(19) United States
(12) Patent Application Publication
(10) Pub. No.: US 2007/0287345 A1
(43) Pub. Date: Dec. 13, 2007

(54) Synthetic nonwoven wallcovering with aqueous ground coating

(76) Inventors: Philip Confalone, Raritan, NJ (US); Rajeev Farwaha, Belle Mead, NJ (US); John C. Parsons, Easton, PA (US)

Correspondence Address: Michael W. Ferrell, Esq.;Ferrells, PLLC, P.O. Box 312, Clifton, VA, 20124-1706, US

(21) Appl. No.: 11/450,752

(22) Filed: Jun. 9, 2006

(51) Int. Cl. B32B 27/02

(52) U.S. Cl. 442/164

(57) ABSTRACT

Wallcoverings which include a nonwoven synthetic substrate and a water-based ground coating which is applied thereto. The ground coating includes emulsion polymer pigment binders and a mineral pigment composition. The ground coating provides the nonwoven substrate with superior printing and durability properties, enabling the production of wallcoverings which may be printed with a decorative design. The wallcoverings are desirable for environmental, health, and safety reasons.

### TECHNICAL FIELD

The present invention relates generally to wallcoverings comprising synthetic nonwoven substrates which are provided with a ground coating layer. The ground coating includes an aqueous emulsion resin and a mineral pigment composition. The wallcoverings exhibit improved strength and durability, and are desirable from a health and environmental perspective.

### BACKGROUND OF THE INVENTION

Wallcovering products have traditionally been made from paper substrates or fabric-backed vinyl materials. Paper wallcoverings generally include a substrate of bonded pulp fibers which include a ground coating on one surface comprising mineral pigments. The wallpaper is usually machine printed with a design. Although paper-based wallcoverings are inexpensive, they suffer from significant drawbacks including low strength, inconsistent wet expansion and dimensional stability during handling and hanging, and poor strippability when the wallcovering is replaced. Paper based wallcoverings are also associated with health and safety concerns, because they are not fire resistant and tend to support mold growth.

Vinyl-based wallcoverings, which are widely used in commercial establishments, typically include a printed polyvinyl chloride (PVC) substrate which is attached to a fabric scrim backing. The scrim backing is added to give the PVC substrate more strength and support. The scrim backing is also included to provide dimensional stability during installation, as PVC substrates exhibit excessive stretching when hung. While PVC wallcoverings are somewhat more durable than paper wallcoverings, they are associated with numerous health concerns. For example, aside from having an offensive odor, the PVC wallcoverings contain toxins and carcinogens such as residual vinyl chloride monomer, and heavy metals or phthalates which are used as vinyl additives. PVC wallcoverings also produce toxic emissions when ignited, such as HCl and dioxin, which are dangerous in cases of accidental fire. Furthermore, vinyl wallcoverings have a low air permeability which can promote dangerous mold growth inside walls in high humidity environments. From an environmental standpoint, PVC wallcoverings are problematic because they are not biodegradable in landfills.

Many wallcoverings which are commercially available today include a nonwoven substrate which comprises pulp fibers and a minor amount of synthetic fibers (about 15 wt. %). While the inclusion of synthetic fibers increases the strength of the substrates, they do not approach the durability of vinyl substrates, and still have many of the drawbacks associated with cellulosic wallcoverings. Moreover, wallcovering sheets which include minor amounts of synthetic fiber are generally produced by wet laid processes which are not preferred for economic reasons.

Nonwovens comprising predominantly synthetic fibers are not usually employed as wallcoverings because the webs generally have inadequate physical properties. For example, spunbond synthetic webs generally have poor opacity and are not smooth enough to print properly. Spunlaced nonwoven webs exhibit too much stretching for wallcovering applications. Brief descriptions of various prior art wallcoverings are summarized below.

U.S. Pat. Nos. 5,876,551 and 6,238,789, both to Jackson, relate to a breathable wallcovering which includes a layer of plastisol that is fused to a nonwoven hydroentagled substrate of cellulosic and synthetic fibers. According to Jackson, the nonwoven ply improves the moisture permeability of the wallcoverings, and the plastisol layer provides a smooth layer which may be printed with a polymer-receptive ink.

U.S. Pat. No. 5,302,404 to Rissanen et al. relates to a wallcovering which includes a cellulosic base substrate, and a ground coating layer which includes a latex binder and a water-insoluble pigment. The wallcovering composition in Rissanen et al. is stated to have superior physical properties to PVC wallcoverings, and reduced environmental and health problems.

U.S. Pat. No. 4,460,643 to Stevens et al., discloses a wallcovering comprising a multilayered nonwoven backing which is coupled to a plastisol coating. According to Stevens et al., the nonwoven backing provides a wallcovering with better toughness, embossability, and strippability, among other features. Similarly, U.S. Pat. Nos. 4,874,019 and 4,925,726, both to Whetstone, describe a nonwoven gauze backing for a vinyl wallcovering, where the backing includes textured multi-filament yarn made from synthetic polymers. The gauze backing used in Whetstone is rendered more hydrophilic via the addition of surfactants to the yarn, and the gauze is said to be advantageous because it allows the adhesion of vinyl wallcoverings to walls using water-based adhesives. United States Patent Application Publication No. 2004/0248488 to Tebbetts, also discloses a wallcovering with a top sheet and a scrim backing which is adhered thereto. The top sheet may be a vinyl material and the scrim backing may be a synthetic nonwoven.

U.S. Pat. No. 4,246,311 to Hirst discloses a wallcovering which comprises a polyester nonwoven web and a back coating to prevent the wallcovering adhesive from striking through the web. The nonwoven substrate is impregnated with a saturant, where the saturant is chosen to be compatible to the coating layer; according to Hirst this creates a bond between the two layers which prevents separation. A pattern may also be applied to the front surface of the polyester nonwoven by a gravure or screen printing process.

United States Patent Application Publication No. 2005/0233662 to Kimbrell et al., discloses a composite material that may be used as a wallcovering where the composite includes a synthetic substrate coupled to a backing which has a pressure sensitive adhesive. According to Kimbrell et al., the face of the textile may be transfer printed. The product in Kimbrell et al. is intended to provide a wallcovering which is convenient to apply to walls.

European Patent No. 0375244 to Boodaghians et al., relates to the use of aqueous emulsion resins in pigmented ground coatings for cellulosic wallpaper coverings. The emulsion resins include acrylic or ethylene/vinyl acetate polymers which are reacted with an effective amount of epoxy silane composition. The emulsion polymers are combined with a clay-based coating prior to application on the wallpaper.

Other references of interest include U.S. Pat. No. 6,368,990; U.S. Pat. No. 6,620,746; and European Patent Application No. 0896081, all to Jennergren et al.

Despite the advancements in this field, there still exists a need for wallcoverings that do not present health or fire hazards, are environmentally friendly, and meet several design criteria. Design objectives include high strength, durable, economical, dimensionally stable, easily strippable, and good printability, among other considerations. It has been discovered according to the invention that wallcoverings may be produced which have excellent properties by employing synthetic nonwoven webs having a ground coating layer and a design printed thereon. Among other desirable features, the wallcoverings of the invention (1) do not emit substantial amounts of toxins or carcinogens; (2) may be made flame resistant; (3) are not malodorous; (4) have excellent physical properties; and (5) are economical.

### SUMMARY OF THE INVENTION

According to one aspect of the present invention, there is provided a wallcovering sheet which comprises a nonwoven substrate with a front and back side, where the nonwoven substrate includes at least 50 wt. percent of synthetic polymer fibers. A ground coating, which includes an emulsion binder and a mineral pigment composition, is applied and directly bonded to the front side of the nonwoven. The ground coating layer is then printed to provide a design, pattern, or the like.

In some embodiments, the nonwoven substrate may include at least 75 weight percent synthetic fibers, and usually includes at least 95 weight percent synthetic fibers. The synthetic fibers preferably include polyester fibers, such as polyethylene terephthalate fibers. The nonwoven substrate may formed by spunbond processes, and is suitably substantially free of saturant binder resins. Suitably, the nonwoven substrate may have a basis weight in the range of from 50 to 300 gsm.

The ground coating used in the inventive wallcoverings may include from 5 to 50 weight percent of emulsion polymer, and from 50 to 95 weight percent of a mineral pigment composition on a dry basis. More preferably, the coating includes from 15 to 35 weight percent emulsion polymer and from 65 to 85 weight percent of mineral pigment composition.

The mineral pigment composition used in the ground coating may include, for example, one or more of the following components: clay, calcium carbonate, titanium dioxide, alumina trihydrate, aluminum hydroxide, aluminum oxide, zeolite, talc, calcium sulfoaluminate, silica, zinc oxide, and combinations thereof. If clay is used it may be calcined clay, delaminated clay, or combinations thereof.

The emulsion polymer binder used in the ground coating is not particularly limited and may include acrylic polymers, vinyl ester polymers, acrylamide polymers, styrenic polymers, and combinations thereof. Copolymers of the foregoing are also contemplated, such as vinyl acetate-ethylene copolymers. The emulsion polymers may be stabilized with surfactants. The resins generally have glass transition temperature of less than 40° C., and preferably less than 25° C.

The ground coating is generally applied to the nonwoven substrate such that the ground covering comprises from 5 to 20 weight percent, preferably from 8 to 15 weight percent, of the total wallcovering sheet.

The wallcoverings of the invention have good printing properties and may be printed with water based inks or toners. One measure of printability is smoothness; the wallcoverings of the invention may be at least 10 percent smoother, preferably at least 20 percent smoother, than the nonwoven substrate alone. Surface roughness is measured according to the Parker-print roughness test described in the examples below.

In another aspect of the invention there is provided a wallcovering sheet which includes a nonwoven substrate, ground coating layer, a design on the ground coating layer, and optionally, a prepaste layer. The wallcovering sheet is substantially opaque, and the design may be printed and/or embossed on the wallcovering.

In still another aspect of the invention there is provided a wallcovering which includes a spun-bond nonwoven substrate and a ground coating applied thereto, where the nonwoven substrate includes polyester fibers and is substantially free of saturant binder. The wallcovering sheet may exhibit ink holdout/receptivity ratios in suitable ranges of from 1:1 to 15:1, or from 2:1 to 10:1.

In yet another aspect of the invention there is provided a wallcovering sheet which comprises a nonwoven substrate, a ground coating, and a printing layer, where the nonwoven substrate includes at least 75 wt. percent of polyethylene terephthalate fibers, and the ground coating includes a vinyl acetate-ethylene copolymer and a mineral pigment composition.

The present invention also provides for a method of producing a wallcovering sheet, where the method includes the steps of (a) forming a nonwoven substrate which includes at least 50 wt. percent of synthetic fiber; (b) applying an aqueous ground coating composition to at least one side of the nonwoven substrate, where the ground coating composition includes an emulsion polymer and a mineral pigment composition; (c) drying the coated nonwoven substrate; and (d) printing a design on the coated surface of the substrate.

Still further features and advantages of the invention are apparent from the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention is described in detail below with reference to the following drawings:

FIG. 1 is a schematic diagram of a cross-section of a wallcovering sheet prepared according to the invention;

FIG. 2 is a photograph of a spunbond web of polyethylene terephthalate fibers without a ground coating layer, where it is seen that two coins placed behind the substrate are visible through the web;

FIG. 3 is a photograph of a spunbond web of polyethylene terephthalate fibers provided with a ground coating layer, where it is seen that two coins placed behind the substrate are not distinctly visible; and

FIG. 4 is a photograph of a swatch of wallcovering produced according to the invention that is printed with a design.

### DETAILED DESCRIPTION OF THE INVENTION

The invention is described in detail below with reference to numerous embodiments for purposes of exemplification and illustration only. Modifications to particular embodiments within the spirit and scope of the present invention, set forth in the appended claims, will be readily apparent to those of skill in the art.

Unless more specifically defined below, terminology as used herein is given its ordinary meaning.

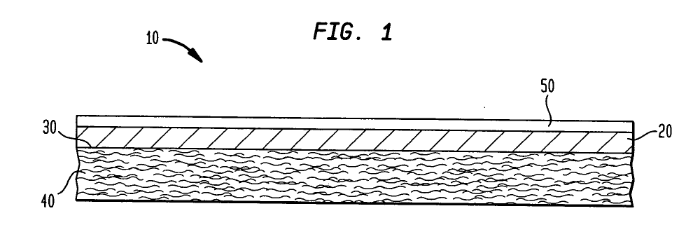

According to the invention, wallcoverings are provided which include a nonwoven web, a ground coating layer, and a pattern or design which is printed on the coating layer. The structure of the present invention is illustrated in FIG. 1, which shows a cross-sectional view of a wallcovering of the invention. As seen in FIG. 1, the wallcovering 10 includes a ground coating layer 20 that is applied directly to the surface 30 of a synthetic nonwoven web 40. The ground coating layer 20 includes an emulsion polymer pigment binder and a mineral pigment composition. Layer 50 represents the printing on the ground coating which imparts the desired pattern or design to the wallcovering.

As noted above, the nonwoven substrates of the invention primarily comprise synthetic fiber, i.e., have at least 50 percent by weight synthetic fiber. The substrate may desirably be at least 75 wt. percent synthetic fiber, at least 95 wt. percent synthetic fiber, and in many embodiments are entirely synthetic fiber. Non-limiting examples of synthetic fibers include polyester fibers such as polyethylene terephthalate (PET) or polybutylene terephthalate (PBT), polypropylene fibers, polyamide fibers, nylon fibers, polyethylene fibers, and the like. The use of bi-component fibers is likewise contemplated. Preferably, the synthetic fibers used in the invention are PET fibers.

Natural fibers may also be included in the nonwoven substrate in amounts of 50 wt. percent or less. Suitable natural fibers include, for example, long fibers such as cotton, rayon, and wool; woody fibers such as those from deciduous and coniferous trees; and other cellulosics such as flax, esparto grass, milkweed, straw, jute, and bagasse, among others. If included, cellulosic fibers are generally added to the nonwoven substrate by coforming techniques.

The nonwoven substrates may be made by various methods, the most preferred being spunbond processes. According to typical spunbond processes, the polymer composition is heated until molten and extruded through a spinneret which contains a plurality of small orifices. Upon exiting the spinneret, the molten fibers are quenched with air. The fibers are then attenuated mechanically or pneumatically at high speeds, prior to being deposited on a moving belt or wire. Depending on the type of die, the individual filaments may need to be separated before being deposited on a forming belt. This may be accomplished by inducing an electrostatic charge onto the fiber bundles before deposition. The filaments may be randomly deposited on the forming belt, or may be oriented somewhat by mechanical or pneumatic means. The deposited web may be further bonded by mechanical needling, thermal bonding, and/or chemical bonding. Various apparatuses and methods for producing spunbond substrates are described in U.S. Pat. Nos. 6,338,814 to Hills; 6,692,601 to Najour et al.; and 4,627,811 to Greiser et al., the entireties of which are incorporated herein by reference.

Advantageously, there is no particular need to use a saturant binder or like composition in the synthetic nonwoven substrate of the present invention, as is common in cellulosic substrates. “Saturants” refer to polymer binders which are applied to the nonwoven substrate and are substantially impregnated throughout the thickness of the web to bind the fibers together, or in some cases to promote adhesion with other layers. In many embodiments of the present invention, the nonwoven substrate is substantially free of saturants, i.e., less than about 1 wt. percent. Notwithstanding, the hydrophilic ground coatings of the invention adhere well to the hydrophobic synthetic fibers, even in the absence of saturant binders or adhesive tie layers. This is unique, as certain synthetic fibers, particularly PET fibers, are notoriously difficult to bond with. In contrast to the present invention, the '311 Hirst reference discussed above, for example, teaches that a saturant which is compatible with the coating must first be imbued in the polyester web to achieve adequate adhesion. See, col. 3, lines 14-18.

According to the invention, the synthetic nonwoven is provided with an aqueous ground coating layer which includes emulsion resin and a mineral pigment composition. The ground coating provides the substrate with numerous properties that are desirable for wallcovering applications, including increased durability, improved printability, higher opaqueness, and surface smoothness, among others.

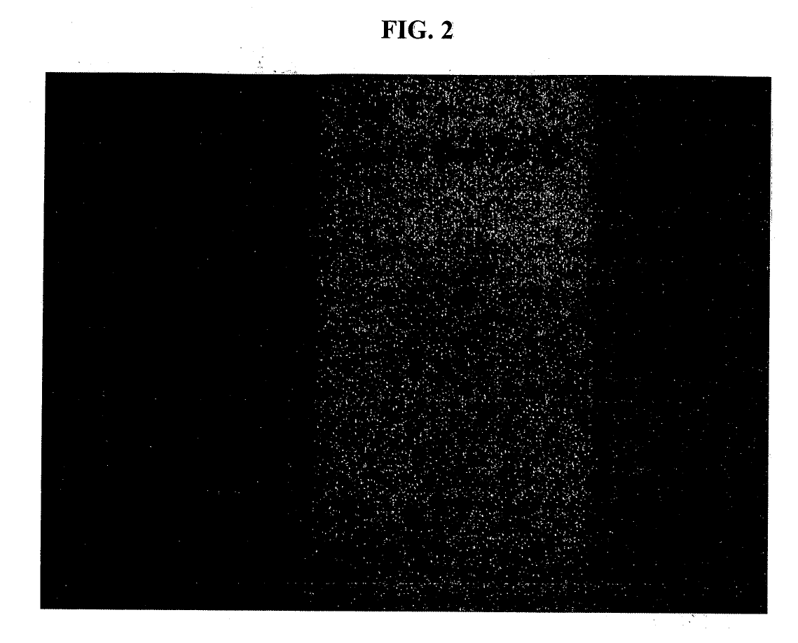

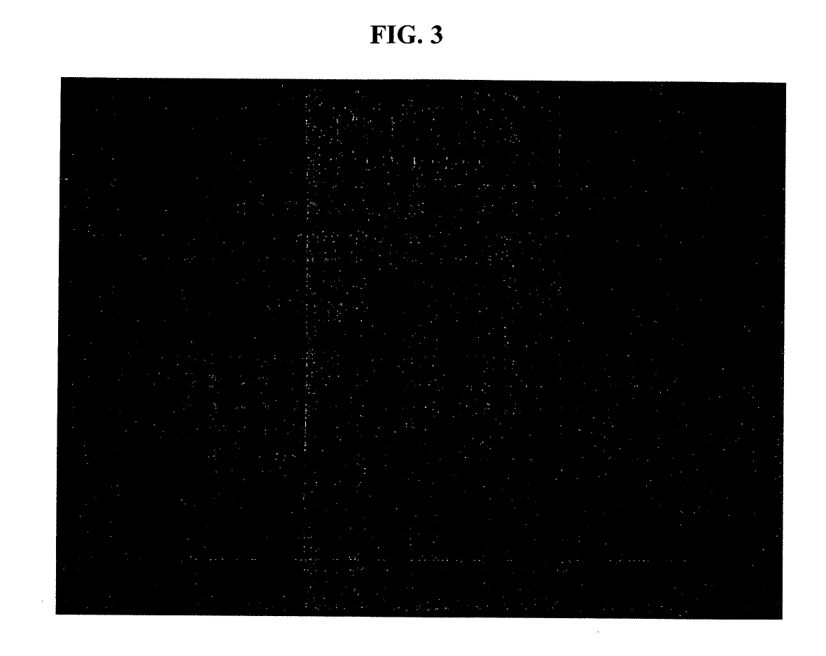

In many wallcoverings opacity is generally a desired feature, and the composition of the ground coating is chosen and the coating is applied in amounts and in a manner such that the coated nonwoven substrate (dried) is substantially opaque. For purposes of the present invention, opacity is measured by TAPPI test method T 425 om-06. If the wallcovering substrate exhibits an opacity of at least about 90 percent on the TAPPI test, the substrate is considered “substantially opaque.” In this regard, reference is made to FIGS. 2 and 3, which show two photographs of spunbond PET webs. FIG. 2 shows a PET substrate which does not include a ground coating, where the substrate was placed in front of two dark (oxidized) pennies; as can be seen, the outlines of the coins are still notably visible through the substrate. In contrast, FIG. 3 is a photograph of a spunbond PET web that is coated with an aqueous ground coating according to the invention. Here, the coins that have been placed behind the coated substrate are, for the most part, indiscernible.

The aqueous ground coatings of the invention typically include from 5 to 50 wt. percent of emulsion resin, and from 50 to 95 wt. percent mineral pigment composition, on a dry basis. More preferably, the coating has 10 to 30 wt. percent emulsion resin, and from 60 to 90 wt. percent of mineral pigment, on a dry basis. The ground coatings used in the invention are provided as aqueous slurries or dispersions and may have a typical solids content ranging from 10 to 90 percent, and more preferably from 40 to 70 percent. The coatings may have viscosities in the following suitable ranges 1 to 2,000 cps, 100 to 1,500 cps, and preferably from 250 to 750 cps.

The emulsion polymer binder used in the aqueous ground coating is not particularly limited. The emulsion polymer may include any synthetic resin which is emulsion polymerized in an aqueous medium and stabilized with emulsifiers and/or protective colloids. Suitable polymers may include, among others, acrylic resins such as those having alkyl acrylate monomers or alkyl methacrylate monomers; vinyl esters resins such as vinyl acetate, vinyl acetate-ethylene copolymers, and VeoVa containing polymers; styrenic resins; and acrylamide polymers. The emulsion polymers may also include functional monomers, for example, carboxylic acid functionalized, hydroxyl functionalized, or sulfonic acid functionalized monomers. Examples of functional monomers include acrylic acid, methacrylic acid, itaconic acid, AMPS, and the like.

The emulsion resins may be either crosslinking or non-crosslinking. Crosslinking resins may include pre-crosslinking or post-crosslinking monomers. Pre-crosslinking monomers include those with two functional groups such as divinyl benzene, allyl(meth)acrylate, diallyl phthalate, diallyl maleate, and triallyl cyanurate. Post-crosslinking monomers include those which react with themselves upon drying/curing. Post-crosslinking monomers include N-methylol (meth)acrylamide and/or N-alkoxy methyl(meth)acrylamide compounds. Specifically, there is contemplated N-methylol acrylamide, N-methylol allyl carbamate, iso-butoxy methyl acrylamide, n-butyoxy methyl acrylamide, or combinations thereof.

Silicon and/or epoxy compounds may also be used as crosslinking agents, including, for example, gamma-acryl- and gamma-methacryloxypropyltri(alkoxy)silanes, gamma-methacyloxymethyltri(alkoxy)silanes, gamma-metharcyloxypropylmethyldi(alkoxy)silanes, vinylalkyldi(alkoxy)silanes, vinyltri(alkoxy)silanes, and combinations thereof. Epoxysilanes may be used as crosslinkers as well, such as glycidyloxypropyltrimethoxysilane. Additionally, the polymers may include comonomers with epoxide groups, as may be present in, for example, glycidyl acrylate, glycidyl metharcylate, allyl glycidyl ether, and vinyl glycidyl ether. Other suitable silicon and/or epoxy compounds may be disclosed in U.S. Pat. No. 6,624,243 to Stark et al. (see, col. 4) and United States Patent Application Publication No. 2004/0077781 to Murase et al., the entireties of which are incorporated herein by reference.

The emulsion resins used in the invention typically have a glass transition temperature (Tg) such that they are able to form films at room temperature. Suitable Tg values may include those of less than 40° C., and preferably less than 25° C. Additionally, the polymer composition may include fugitive plasticizers to reduce the effective film forming temperature of the polymer. Suitable fugitive plasticizers are described in U.S. Pat. No. 4,071,645 to Kahn, the entirety of which is incorporated herein by reference.

As mentioned, the emulsion polymer may include surfactants and/or protective colloids as stabilizers. Preferably, the composition includes surfactants, because it is believed that the surfactants may somewhat promote the adhesion between the ground coating and the synthetic fibers, as the surfactants tend to wet out the hydrophobic fibers.

Suitable surfactants may be either anionic, non-ionic, or cationic. Possible anionic surfactants include fatty acid soaps, alkyl carboxylates, alkyl surlates, alkyl sulfonates, alkali metal alkyl aryl sulfonates, alkali metal alkyl sulfates and sulfonated alkyl esters; specific examples include sodium dodecylbenzene sulfonate, sodium disecondary-butylnaphtalne sulfonate, sodium lauryl sulfate, disodium dodecyidiphenyl ether disulfonate, disodium n-octadecylsulfosuccinate, sodium dioctyl sulfosuccinate, among others. Examples of suitable non-ionic surfactants are the addition products of 5 to 50 moles of ethylene oxide adducted to straight-chained and branch-chained alkanols with 6 to 22 carbon atoms, or alkylphenols of higher fatty acids, or higher fatty acid amides, or primary and secondary higher alkyl amines; as well as block copolymers of propylene oxide with ethylene oxide and mixtures thereof. Cationic surfactants include amines, nitriles, and other nitrogen bases. Examples of cationic surfactants may include alkyl quaternary ammonium salts and alkyl quaternary phosphonium salts, such as: alkyl trimethyl ammonium chloride, dieicosyldimethyl ammonium chloride, didocosyldimethyl ammonium chloride, dioctadecyldimethyl ammonium chloride; dioctadecyldimethyl ammonium methosulphate, ditetradecyidimethyl ammonium chloride, and naturally occurring mixtures of above fatty groups, e.g., di(hydrogenated tallow) dimethyl ammonium chloride; di(hydrogenated tallow) dimethyl ammonium methosulfate, ditallow dimethyl ammonium chloride, and dioleyidimethyl ammonium chloride. Cationically modified polyvinyl alcohol and cationically modified starch may also be used as emulsifying agents.

Protective colloids may also be used as stabilizing agents. Protective colloids used in the art include polyvinyl alcohol polymers, starch derivatives, and cellulose derivatives.

The ground coatings used in the invention also include a mineral pigment composition. The mineral pigment composition used in the invention may be present in the ground coating in amounts of at least about twice that of the emulsion polymer on a dry basis, and preferably at least about three times as much. Non-limiting examples of mineral pigments include clay, calcium carbonate, titanium dioxide, alumina trihydrate, aluminum hydroxide, aluminum oxide, zeolite, talc, calcium sulfoaluminate, silica, zinc oxide, and combinations thereof. Alumina trihydrate may also be used as a mineral pigment, and has the advantage of imparting flame resistance to the wallcovering. In preferred embodiments, the mineral pigment composition includes clay compounds; suitable clay compounds include kaolin, bentonite, and the like. The clay may be calcined, delaminated, water-washed or airfloat hard clay.

In addition to the emulsion resin binder and the mineral pigment composition, other additives may be included in the ground coating. Non-limiting examples include pigment dispersant, rheology modifiers, thickening agents, detackifying agents, lubricants, defoaming agents, fugitive alkali agents, humectants, and preservatives, among others.

The ground coating should be prepared and applied to the nonwoven web, such that it is directly bonded to the surface of the synthetic substrate, creating a printable layer upon drying. The ground coatings of the invention may be applied to the synthetic nonwoven substrate by any suitable means, including blade coating, air knife, rod, roll coating methods, curtain coating, foam coating, and size press coating. The ground coating should be provided in amounts such that the coating comprises from 5 to 25 wt. percent of the wallcovering, preferably from 8 to 15 percent. As mentioned above, the ground coatings are generally operative to improve the optical and printing properties of the nonwoven web. For example, smoother surfaces are better for printing, and the ground coatings used in the invention are typically effective to increase the smoothness of the nonwoven substrate by at least 10 percent, preferably 20 percent, (when measured according to Parker-printing roughness test using a hard backing with 5 kg of force). The wallcoverings also exhibit good gloss, brightness, and yellowness, as is apparent from the examples which follow.

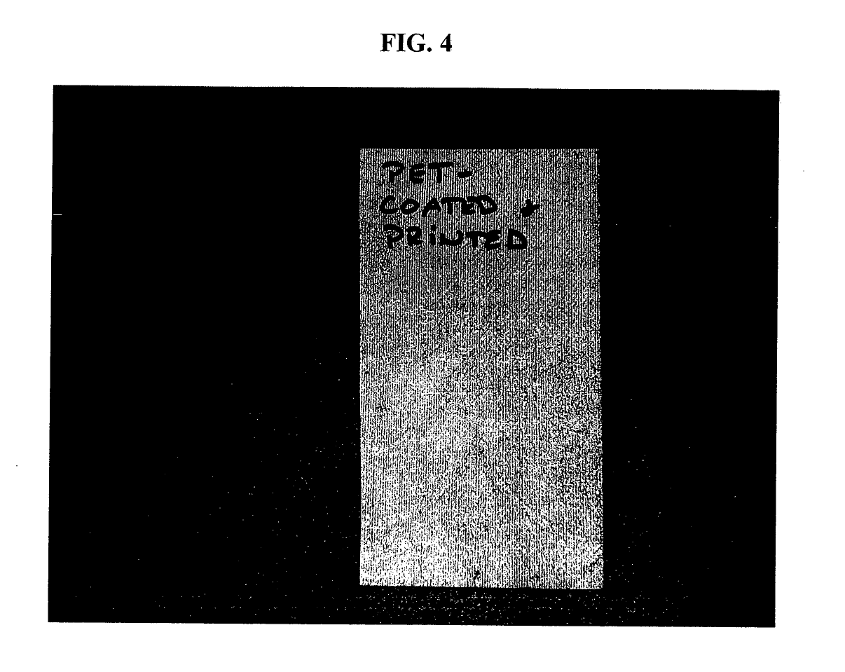

In this regard, the wallcovering sheets of the invention are readily provided with a pattern or design by printing and/or embossing. See, for example, FIG. 4 which is a photograph of a swatch of printed wallcovering which is produced according to the invention. The wallcovering in FIG. 4 comprises a spunbond PET web which includes a ground coating layer, and has a design printed thereon. Various printing and/or embossing processes may be used to impart a pattern or design to the surface of the wallcoverings. Suitable printing processes as are known in the art include gravure printing, screen printing, digital printing, and the like. Additionally, due to the presence of the hydrophilic ground coating, the inventive wallcoverings enable the use of water-based inks in printing, which are preferred in many processes. Toners may also be used in to print the inventive wallcoverings. Embossing processes entail subjecting the sheet to pressure and/or heat using textured rolls or plates, which imparts the texture pattern to the substrate. Methods of printing and/or embossing wallcoverings are described in U.S. Pat. No. 5,989,380 to Frischer and U.S. Pat. No. 5,950,533 to Kildune et al., the entireties of which are incorporated herein by reference.

The wallcoverings of the invention may optionally include a prepaste layer. Prepaste layers comprise an adhesive which is applied to the back of the wallcovering sheet and dried, such that the wallcovering may be conveniently installed by wetting the prepaste layer. Thus, the need for applying additional adhesive is obviated in embodiments which are provide with a prepaste layer.

Additional layers may also be included in the wallcoverings of the invention; for example, additional nonwoven layers, polymeric film layers, other coatings and the like may be included.

Desirably, the wallcovering is formed such that it has a basis weight in the range of from 50 to 300 g/m², and preferably in the range of from 100 to 200 g/m².

Further features of the invention are illustrated in the examples which follow.

### EXAMPLES

Twelve aqueous ground coatings of the invention were prepared with emulsion pigment binders and mineral pigments, and then applied to spunbond PET substrates. The general composition of the emulsion pigment binders used in examples 1-12 is outlined in Table 1, below. The pH of each emulsion pigment binder was adjusted to a minimum of about 5 to 5.5 with ammonium to enhance pigment compatibility.

TABLE 1
Emulsion Binder Composition

| Emulsion | | pH | Tg |
|---|---|---|---|
| Binder | Name | (adjusted) | (° C.) |
| Binder # 1 | NACRYLIC ® 4460 | 5.4 | −30 |
| Binder # 2 | NACRYLIC ® 4484 | 5.2 | −37 |
| Binder # 3 | VINACRYL ® 8961 | 8.0 | 3 |
| Binder # 4 | NACRYLIC ® 4104 | 7.2 | 0 |
| Binder # 5 | MOWILITH ® LDM 7411S | 8.0 | −10 |
| Binder # 6 | DUR-O-SET ® 135A | 5.2 | 5 |
| Binder # 7 | Experimental Binder A | 5.2 | −10 |
| | (Acrylic polymer) | | |
| Binder # 8 | Experimental Binder B | 5.3 | −8 |
| | (Acrylic polymer) | | |
| Binder # 9 | Experimental Binder C | 5.2 | 7 |
| | (Vinyl Acetate-Acrylate | | |
| | polymer) | | |
| Binder # 10 | AP AIRFLEX ® 100HS | 6.0 | 7 |

The emulsion pigment binders were combined with mineral pigment compositions to produce the ground coatings. The compositions of the aqueous ground coatings (dry weight basis) in Examples 1-12 are outlined in Table 2, below.

TABLE 2
Ground Coating Composition

| | | EXAMPLE | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Mineral | Delaminated clay | 63 | 63 | 63 | 63 | 63 | 63 | 63 | 63 | 63 | 63 | 51 | — |
| Pigments | (Imerys Astraplate ®) | | | | | | | | | | | | |
| (parts per | Calcined clay | 16 | 16 | 16 | 16 | 16 | 16 | 16 | 16 | 16 | 16 | 12 | — |
| hundred | (Imerys Alphatex ®) | | | | | | | | | | | | |
| weight, | Alumina trihydrate | — | — | — | — | — | — | — | — | — | — | 16 | — |
| dry basis) | (Albermarle | | | | | | | | | | | | |
| | Martingloss ®) | | | | | | | | | | | | |
| | Calcium carbonate | — | — | — | — | — | — | — | — | — | — | — | 63 |
| | (Omya Hydrocarb ®) | | | | | | | | | | | | |
| | No. 1 High | — | — | — | — | — | — | — | — | — | — | — | 16 |
| | Brightness Clay | | | | | | | | | | | | |
| | (Huber Hydrafine ®) | | | | | | | | | | | | |
| Emulsion | Binder # 1 | 20 | — | — | — | — | — | — | — | — | — | — | — |
| Binder | Binder #2 | — | 20 | — | — | — | — | — | — | — | — | — | — |
| (parts per | Binder #3 | — | — | 20 | — | — | — | — | — | — | — | — | — |
| hundred | Binder #4 | — | — | — | 20 | — | — | — | — | — | — | — | — |
| weight, | Binder #5 | — | — | — | — | 20 | — | — | — | — | — | — | — |
| dry basis) | Binder #6 | — | — | — | — | — | 20 | — | — | — | — | — | — |
| | Binder #7 | — | — | — | — | — | — | 20 | — | — | — | — | — |
| | Binder #8 | — | — | — | — | — | — | — | 20 | — | — | — | — |
| | Binder #9 | — | — | — | — | — | — | — | — | 20 | — | — | — |
| | Binder #10 | — | — | — | — | — | — | — | — | — | 20 | — | — |
| | Binder #6 | — | — | — | — | — | — | — | — | — | — | 20 | — |
| | Binder #6 | — | — | — | — | — | — | — | — | — | — | — | 20 |
| Other | Pigment dispersant | 0.2 | 0.2 | 0.2 | 0.2 | 0.2 | 0.2 | 0.2 | 0.2 | 0.2 | 0.2 | 0.2 | 0.2 |
| Additives | (Alco | | | | | | | | | | | | |
| (parts per | Alcosperse ® 149) | | | | | | | | | | | | |
| hundred | Rheology modifier | 0.2 | 0.2 | 0.2 | 0.2 | 0.2 | 0.2 | 0.2 | 0.2 | 0.2 | 0.2 | 0.2 | 0.2 |
| weight, | (Hercules CMC 7LT) | | | | | | | | | | | | |
| dry basis) | Lubricant | 0.6 | 0.6 | 0.6 | 0.6 | 0.6 | 0.6 | 0.6 | 0.6 | 0.6 | 0.6 | 0.6 | 0.6 |
| | (Bercen | | | | | | | | | | | | |
| | Berchem ® 4000) | | | | | | | | | | | | |
| | Defoamer | .008 | .008 | .008 | .008 | .008 | .008 | .008 | .008 | .008 | .008 | .008 | .008 |
| | (Cognis | | | | | | | | | | | | |
| | Foamaster ® VMS) | | | | | | | | | | | | |
| | Fugitive Alkali | .008 | .008 | .008 | .008 | .008 | .008 | .008 | .008 | .008 | .008 | .008 | — |
| | (Aq. Ammonia) | | | | | | | | | | | | |

The above ground coating compositions were measured for percent solids, Brookfield viscosity, and coating pH; the results are shown in Table 3, below.

TABLE 3
Coating Properties

| | | Brookfield | |
|---|---|---|---|
| | Solids | Viscosity | Coating |
| Example | (%) | (cps) | pH |
| 1 | 55 | 1385 | 7.0 |
| 2 | 55 | 1045 | 6.9 |
| 3 | 55 | 695 | 7.6 |
| 4 | 55 | 566 | 7.0 |
| 5 | 55 | 575 | 7.5 |
| 6 | 55 | 870 | 7.0 |
| 7 | 55 | 675 | 7.0 |
| 8 | 55 | 700 | 7.0 |
| 9 | 55 | 615 | 7.0 |
| 10 | 55 | 1040 | 7.0 |
| 11 | 55 | 695 | 7.0 |
| 12 | 60 | 510 | 7.2 |

The fabric samples were prepared by coating the smoothest side of a PET spunbond stock using a wirewound rod to achieve a target coating weight in the range of about 15-20 gsm. The spunbond PET substrates had basis weights of about 130 gsm. The coated PET substrates were measured for gloss, brightness, brightness stability, yellowness, printability, scrubbability, opacity, ink holdout, ink receptivity, and in some cases flame resistance. For comparison, a web of spunbond PET fibers without any ground coating was tested as a control (“C.”). A brief description of the test procedures follows.

The 75 degree Hunter gloss test measures the reflectance of light when it hits the surface of the substrate at a 75 degree incidence angle. Higher values indicate higher gloss.

The TAPPI Brightness (sometimes referred to as whiteness) defines substrate brightness as the reflectance of blue light at 457 nm, and is measured according to TAPPI method T452 om-02. Higher brightness values indicate a whiter substrate (scale 0 to 100, where 100=perfect white), which is generally preferred in the wallcoverings industry. The brightness or whiteness of a substrate is inversely related to its yellowness.

The brightness stability test measures the aging stability of the wallcovering color. This is also referred to as the light-fastness or QUV fluorescent test. In this experiment, swatches of coated substrate are exposed to UV light (simulating sunlight) for several days. Exposure to UV light can turn some substrates yellow, which is not desirable in wallcovering applications. The brightness stability test illustrates a substrate's resistance to yellowing with time.

The “Hunter b value” test is another way to measure the whiteness of a substrate. Here, the higher the b value, the more yellow the color. A positive number relates to yellowness, and a negative number relates to blueness/whiteness. Accordingly, the lower the number, the whiter the substrate appears. Note, these samples were tested for aging stability as well.

The Parker-print Roughness test (also referred to as the Parker-print Smoothness test) measures the surface smoothness of a substrate. The Parker-print test is measured in accordance with TAPPI T55 m⁻⁰⁴ using a hard backing with either a 5 kg/cm² clamping force (H.5) or a 10 kg/cm² clamping force (H.10). The roughness results are reported in microns, with higher values corresponding to rougher surfaces. Roughness is generally considered undesirable because it negatively influences the printability of the substrate on gravure printing presses, which are commonly used to print wallcovering.

The Gardner scrubbability test measures the durability of the wallcoverings to withstand routine washing, and is also indicative adhesion of the groundcoat to the spunbonded base. The scrubbability test is known in the wallcovering field and is conducted by scrubbing a swatch of the nonwoven substrate with a 1% soap solution (pH 9.6 w/NaOH), using a bristle brush. The test results indicate the number of cycles until the first visual sign of surface damage appears. Preferably, the wallcoverings achieve values on the scrubbability test of at least 50, at least 100, or even as high as 150 or more.

The opacity tests are measured according to TAPPI test method T 425 om-06. The opacity results are reported in percentage. Preferably the wallcoverings of the invention exhibit opacity values of at least about 90 percent.

The K&N Ink holdout and Ink receptivity tests are measures of printability; the “ink receptivity” refers to the ink adhesion to the substrate and the “ink holdout” refers to the amount of ink that remains on the surface of a substrate. Printers require a balance in ink receptivity/absorption (for good ink adhesion to the surface of the substrate) and ink holdout (desirable for high print gloss upon drying). The K&N tests are conducted as follows: First, a lab technician tests the brightness (TAPPI) of the substrate as received. Next, a thick coating of K&N ink (dark gray color) is applied to the surface of the substrate and allowed to absorb for 2 minutes. After 2 minutes, the ink is removed with a spatula and wiped clean with a non-absorbent fabric, leaving the surface stained by the ink. The brightness of the stained surface is measured again. Ink holdout and ink receptivity are calculated as follows:

$$Ink Holdout = ( \frac{TAPPI Brightness Stained Substrate}{TAPPI Brightness Unstained Substrate} ) \times 100$$

$$Ink Receptivity = [ 1 - ( \frac{TAPPI Brightness Stained Substrate}{TAPPI Brightness Unstained Substrate} ) ] \times 100$$

Higher brightness values on the stained surface correspond to higher ink holdouts, and vice versa. The holdout and receptivity values add up to 100. It is generally preferred for the ink holdout to be somewhat higher than the ink receptivity. Preferred ink holdout to ink receptivity ratios are in the range of 1:1 to 15:1, and more preferably from 2:1 to 10:1.

To test for fire resistance, swatches of the substrates were exposed to the flame of a propane torch and the observed time to ignition, flame spreading, and smoke color were recorded.

The results of the above assays are illustrated in Table 4, below.

TABLE 4
Coated Fabric Properties

| | Example | | | | | | | | | | | | |
|---|---|---|---|---|---|---|---|---|---|---|---|---|---|
| | C. | 1 | 2 | 3 | 4 | 5 | 6 | 7 | 8 | 9 | 10 | 11 | 12 |
| Basis weight | | | | | | | | | | | | | |
| (gsm) | | | | | | | | | | | | | |
| Avg. | 115 | 132 | 133 | 132 | 133 | 133 | 136 | 133 | 134 | 133 | 134 | 134 | 134 |
| STD × 2 | 4.7 | 7.0 | 2.7 | 7.5 | 4.2 | 2.7 | 4.6 | 4.4 | 4.6 | 5.5 | 4.3 | 4.4 | 5.2 |
| High | 120 | 139 | 136 | 140 | 137 | 136 | 141 | 137 | 139 | 139 | 138 | 139 | 139 |
| Low | 111 | 125 | 130 | 125 | 128 | 131 | 131 | 129 | 130 | 128 | 129 | 130 | 129 |
| Coating | | | | | | | | | | | | | |
| weight (gsm) | | | | | | | | | | | | | |
| Avg. | 0.0 | 18 | 18 | 18 | 17 | 17 | 17 | 16 | 16 | 17 | 18 | 18 | 19 |
| STD × 2 | 0.0 | 1.0 | 0.8 | 0.4 | 0.7 | 1.2 | 1.4 | 1.3 | 0.9 | 0.8 | 1.0 | 0.9 | 1.1 |
| High | 0.0 | 19 | 19 | 18 | 17.5 | 19 | 18 | 17 | 17 | 18 | 19 | 19 | 20 |
| Low | 0.0 | 17 | 17 | 17 | 16.2 | 16 | 16 | 14 | 15 | 16 | 17 | 17 | 18 |
| 75° Hunter | | | | | | | | | | | | | |
| Gloss | | | | | | | | | | | | | |
| Avg. | 3.9 | 15 | 14 | 14 | 16 | 17 | 15 | 19 | 19 | 19 | 13 | 15 | 6.3 |
| STD × 2 | 1.2 | 1.4 | 1.3 | 2.6 | 3.7 | 3.4 | 3.0 | 2.7 | 1.6 | 2.7 | 2.1 | 4.1 | 2.0 |
| High | 5.1 | 17 | 15 | 17 | 20 | 21 | 18 | 22 | 21 | 22 | 15 | 19 | 8.3 |
| Low | 2.7 | 14 | 13 | 12 | 12 | 14 | 12 | 16 | 18 | 17 | 11 | 10 | 4.3 |
| TAPPI | | | | | | | | | | | | | |
| Brightness | | | | | | | | | | | | | |
| Avg. | 85 | 80 | 80 | 81 | 80 | 80 | 82 | 80 | 80 | 81 | 81 | 82 | 83 |
| STD × 2 | 1.6 | 0.1 | 0.9 | 0.9 | 0.2 | 0.2 | 1.4 | 0.9 | 0.6 | 0.3 | 1.1 | 0.8 | 1.3 |
| High | 86 | 80 | 81 | 82 | 80 | 80 | 83 | 81 | 80 | 81 | 82 | 83 | 84 |
| Low | 83 | 80 | 79 | 80 | 80 | 80 | 80 | 79 | 79 | 80 | 80 | 81 | 81 |
| Brightness | | | | | | | | | | | | | |
| Stability, 3 | | | | | | | | | | | | | |
| days. | | | | | | | | | | | | | |
| Avg. | 84 | 79 | 80 | 79 | 79 | 78 | 81 | 79 | 79 | 79 | 81 | 82 | 82 |
| STD × 2 | 1.6 | 05 | 0.6 | 1.0 | 0.2 | 0.3 | 1.1 | 0.8 | 0 | 0.5 | 0.2 | 1.3 | 0.9 |
| High | 86 | 79 | 81 | 80 | 80 | 79 | 82 | 79 | 79 | 80 | 81 | 83 | 83 |
| Low | 82 | 78 | 79 | 78 | 79 | 78 | 80 | 78 | 79 | 79 | 81 | 80 | 81 |
| Brightness | | | | | | | | | | | | | |
| Stability, 1 | | | | | | | | | | | | | |
| week. | | | | | | | | | | | | | |
| Avg. | 81 | 78 | 79 | 79 | 79 | 78 | 80 | 78 | 78 | 78 | 80 | 80 | 80 |
| STD × 2 | 0.9 | 0.3 | 1.0 | 0.4 | 0.7 | 0.7 | 0.9 | 0.6 | 0.6 | 0.8 | 1.1 | 0.9 | 0.8 |
| High | 82 | 78 | 80 | 79 | 80 | 78 | 81 | 79 | 79 | 79 | 81 | 81 | 81 |
| Low | 81 | 78 | 78 | 79 | 78 | 77 | 79 | 78 | 77 | 77 | 79 | 78 | 80 |
| Hunter | | | | | | | | | | | | | |
| yellowness | | | | | | | | | | | | | |
| Avg. | −1.5 | 4.7 | 4.7 | 4.8 | 4.7 | 4.9 | 3.8 | 4.9 | 4.9 | 4.4 | 4.3 | 2.1 | −1.5 |
| STD × 2 | 0.1 | 0.09 | 0.05 | 0.12 | 0.1 | 0.13 | 0.13 | 0.07 | 0.12 | 0.11 | 0.16 | 0.18 | 0.17 |
| High | −1.4 | 4.8 | 4.8 | 4.9 | 4.8 | 5.0 | 3.9 | 4.9 | 5.1 | 4.5 | 4.5 | 2.3 | −1.3 |
| Low | −1.6 | 4.6 | 4.7 | 4.7 | 4.6 | 4.8 | 3.6 | 4.8 | 4.8 | 4.3 | 4.1 | 2.0 | −1.6 |
| Yellowness, | | | | | | | | | | | | | |
| 3 days | | | | | | | | | | | | | |
| Avg. | −1.3 | 5.1 | 5.0 | 5.5 | 5.0 | 5.3 | 4.0 | 5.0 | 5.0 | 4.9 | 4.4 | 4.0 | 1.5 |
| STD × 2 | 0.09 | 0.07 | 0.07 | 0.05 | 0.15 | 0.14 | 0.09 | 0.09 | 0.09 | 0.19 | 0.20 | 0.22 | 0.04 |
| High | −1.2 | 5.2 | 5.0 | 5.6 | 5.1 | 5.4 | 4.1 | 5.1 | 5.1 | 5.0 | 4.6 | 4.3 | 1.5 |
| Low | −1.4 | 5.0 | 4.9 | 5.5 | 4.8 | 5.1 | 4.0 | 4.9 | 4.9 | 4.7 | 4.2 | 3.8 | 1.5 |
| Yellowness, | | | | | | | | | | | | | |
| 1 week | | | | | | | | | | | | | |
| Avg. | −1.0 | 5.3 | 5.4 | 5.6 | 5.3 | 5.5 | 4.5 | 5.5 | 5.3 | 5.0 | 4.5 | 4.3 | 2.0 |
| STD × 2 | 0.24 | 0.04 | 0.04 | 0.02 | 0.07 | 0.05 | 0.05 | 0.11 | 0.02 | 0.11 | 0.02 | 0.11 | 0.12 |
| High | −.78 | 5.3 | 5.4 | 5.7 | 5.4 | 5.6 | 4.5 | 5.6 | 5.4 | 5.1 | 4.6 | 4.4 | 2.1 |
| Low | −1.3 | 5.2 | 5.3 | 5.6 | 5.2 | 5.5 | 4.4 | 5.4 | 5.3 | 4.9 | 4.5 | 4.2 | 1.9 |
| Parker-print | | | | | | | | | | | | | |
| Roughness | | | | | | | | | | | | | |
| H.5 (μm) | | | | | | | | | | | | | |
| Avg. | 9.6 | 7.2 | 7.2 | 7.4 | 7.1 | 7.2 | 7.2 | 7.9 | 7.0 | 7.2 | 7.8 | 7.3 | 7.8 |
| STD × 2 | 0.2 | 0.09 | 0.19 | 0.09 | 0.09 | 0.25 | 0.25 | 0.25 | 0.16 | 0.09 | 0.16 | 0.25 | 0.09 |
| High | 9.8 | 7.3 | 7.4 | 7.5 | 7.2 | 7.4 | 7.5 | 8.2 | 7.2 | 7.3 | 8.0 | 7.6 | 7.9 |
| Low | 9.4 | 7.1 | 7.0 | 7.3 | 7.0 | 6.9 | 7.0 | 7.7 | 6.8 | 7.1 | 7.6 | 7.1 | 7.7 |
| Parker-print | | | | | | | | | | | | | |
| Roughness | | | | | | | | | | | | | |
| H.10 (μm) | | | | | | | | | | | | | |
| Avg. | 7.6 | 6.4 | 6.4 | 6.5 | 6.6 | 6.8 | 6.4 | 6.2 | 6.4 | 6.3 | 6.3 | 6.3 | 6.1 |
| STD × 2 | 0.21 | 0.09 | 0.09 | 0.09 | 0.25 | 0.38 | 0.16 | 0.16 | 0.09 | 0.25 | 0.25 | 0.19 | 0.09 |
| High | 7.8 | 6.5 | 6.5 | 6.6 | 6.8 | 7.2 | 6.6 | 6.4 | 6.5 | 6.5 | 6.6 | 6.5 | 6.2 |
| Low | 7.4 | 6.3 | 6.3 | 6.4 | 6.3 | 6.4 | 6.2 | 6.0 | 6.3 | 6.0 | 6.0 | 6.1 | 6.0 |
| Gardner | | | | | | | | | | | | | |
| Scrubbability | | | | | | | | | | | | | |
| (cycles) | | | | | | | | | | | | | |
| Avg. | 12 | 219 | 195 | 203 | 196 | 228 | 186 | 175 | 189 | 203 | 160 | 103 | 94 |
| STD × 2 | 10 | 16 | 16 | 16 | 14 | 14 | 12 | 16 | 12 | 16 | 14 | 2 | 12 |
| High | 22 | 235 | 211 | 219 | 210 | 242 | 198 | 191 | 201 | 219 | 174 | 105 | 106 |
| Low | 2 | 203 | 179 | 187 | 182 | 214 | 174 | 159 | 177 | 187 | 146 | 101 | 82 |
| TAPPI | | | | | | | | | | | | | |
| Opacity (%) | | | | | | | | | | | | | |
| Avg. | 84.5 | 92.2 | 92.6 | 94.7 | 95.0 | 93.1 | 95.8 | 92.0 | 92.8 | 95.0 | 93.9 | 91.4 | 89.9 |
| STD × 2 | 1.1 | 0.3 | 0.6 | 0.3 | 0.1 | 0.2 | 0.3 | 0.2 | 0.7 | 0.4 | 0.8 | 0.6 | 0.1 |
| High | 85.6 | 92.5 | 93.2 | 95.0 | 95.1 | 93.3 | 96.1 | 92.2 | 93.5 | 95.4 | 94.7 | 92.0 | 90.0 |
| Low | 83.4 | 91.9 | 92.0 | 94.4 | 94.9 | 92.9 | 95.5 | 91.8 | 92.1 | 94.6 | 93.1 | 90.8 | 89.8 |
| K & N Ink | 46.8 | 84.5 | 83.6 | 89.9 | 86.7 | 92.5 | 81.2 | 91.3 | 91.1 | 85.4 | 80.0 | 81.1 | 65.3 |
| Holdout % | | | | | | | | | | | | | |
| K & N Ink | 53.2 | 15.5 | 16.4 | 10.1 | 13.3 | 7.5 | 18.8 | 8.7 | 8.9 | 14.6 | 20.0 | 18.9 | 34.7 |
| Receptivity | | | | | | | | | | | | | |
| % | | | | | | | | | | | | | |
| Flame | | | | | | | | | | | | | |
| Resistance | | | | | | | | | | | | | |
| Time to | n/a | — | — | — | — | — | 4 | — | — | — | — | 6 | — |
| ignition (s) | | | | | | | | | | | | | |
| Flame spread | No, | — | — | — | — | — | Yes, | — | — | — | — | Yes, | — |
| | melts | | | | | | fast | | | | | slow | |
| Smoke | Yes, | — | — | — | — | — | Yes, | — | — | — | — | Yes, | — |
| | blk. | | | | | | blk. | | | | | blk. | |

As can be seen from the above data, the webs of the invention provide synthetic wallcoverings which have excellent durability and visual properties. For example, the nonwoven substrate can be provided with acceptable brightness and yellowness values, which remain relatively stable upon aging. The gloss values are likewise acceptable, and may be varied by selecting the type and amounts of mineral pigments. Further, the printability of the substrates is substantially improved, as evidenced by the smoother surface, greater opacity, and a good ink holdout to ink receptivity ratio. Other properties, such as the scrubbability of the substrates is significantly improved, with the coated substrates exhibiting results that are typically at least 8-fold, and in some instances 15-fold better than the uncoated surface.

Significantly, the above examples illustrate that superior wallcoverings can be provided using a wide variety of emulsion polymers and mineral pigments in the ground coating layer.

While the invention has been illustrated in connection with several examples, modifications to these examples within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary

1. A wallcovering sheet comprising:
a) a nonwoven substrate having a front side and a back side, wherein the nonwoven substrate includes at least 50 wt. percent synthetic polymer fibers;
b) a ground coating layer applied to the front side of the nonwoven substrate and directly bonded thereto, wherein said ground coating includes
i) an emulsion polymer pigment binder; and
ii) a mineral pigment composition, and
c) printing which is applied on the ground coating layer.

2. The wallcovering sheet according to claim 1, wherein the nonwoven substrate includes at least 75 wt. percent synthetic fibers.

3. The wallcovering sheet according to claim 1, wherein the nonwoven substrate includes at least 95 wt. percent synthetic fibers.

4. The wallcovering sheet according to claim 3, wherein the nonwoven substrate includes polyester fibers.

5. The wallcovering sheet according to claim 4, wherein the polyester fibers include polyethylene terephthalate fibers.

6. The wallcovering sheet according to claim 1, wherein the nonwoven substrate is substantially free of saturant binder resin.

7. The wallcovering sheet according to claim 1, wherein the ground coating includes from 5 to 50 wt. percent of emulsion polymer, and from 50 to 95 wt. percent of the mineral pigment composition, on a dry basis.

8. The wallcovering sheet according to claim 1, wherein the ground coating includes from 15 to 35 wt. percent of emulsion polymer, and from 65 to 85 wt. percent of the mineral pigment composition, on a dry basis.

9. The wallcovering sheet according to claim 1, wherein the mineral pigment composition is selected from the group consisting of clay, calcium carbonate, titanium dioxide, alumina trihydrate, aluminum hydroxide, aluminum oxide, zeolite, talc, calcium sulfoaluminate, silica, zinc oxide, and combinations thereof.

10. The wallcovering sheet according to claim 1, wherein the mineral pigment composition includes clay.

11. The wallcovering sheet according to claim 12, wherein the clay includes calcined clay, delaminated clay, or combinations thereof.

12. The wallcovering sheet according to claim 1, wherein the emulsion polymer is selected from the group consisting of acrylic polymers, vinyl ester polymers, acrylamide polymers, styrenic polymers, and combinations thereof.

13. The wallcovering sheet according to claim 1, wherein the emulsion polymer includes a vinyl acetate-ethylene copolymer.

14. The wallcovering sheet according to claim 1, wherein the emulsion polymer includes surfactants.

15. The wallcovering sheet according to claim 1, wherein the emulsion polymer has a glass transition temperature of less than 40° C.

16. The wallcovering sheet according to claim 1, wherein the emulsion polymer has a glass transition temperature of less than 25° C.

17. The wallcovering sheet according to claim 1, wherein the ground coating comprises from 5 to 20 weight percent of the wallcovering sheet.

18. The wallcovering sheet according to claim 1, wherein the ground coating comprises from 8 to 15 weight percent of the wallcovering sheet.

19. The wallcovering sheet according to claim 1, wherein the ground coating is applied such that the nonwoven substrate exhibits a decrease in roughness of at least about a 10 percent when measured according to the Parker-print roughness test using hard backing and a 5 kg clamping force.

20. The wallcovering sheet according to claim 1, wherein the ground coating is applied such that the nonwoven substrate exhibits a decrease in roughness of at least about a 20 percent when measured according to the Parker-print roughness test using a hard backing and a 5 kg clamping force.

21. The wallcovering sheet according to claim 1, wherein the pattern is printed with water-based inks and/or toners.

22. The wallcovering sheet according to claim 1, wherein the nonwoven substrate is a spun-bond fabric.

23. The wallcovering sheet according to claim 1, wherein the nonwoven substrate has a basis weight in the range of from 50 to 300 g/m².

24. A wallcovering sheet comprising:
a) a nonwoven substrate having a front side and a back side, wherein the nonwoven substrate includes at least 75 wt. percent synthetic polymer fibers;
b) a ground coating layer applied to the front side of the nonwoven substrate and directly bonded thereto, wherein said ground coating includes
i) an emulsion polymer pigment binder; and
ii) a mineral pigment composition,
c) a design which is provided on the ground coating layer, and
d) optionally, a prepaste layer applied to the back side of the nonwoven substrate,
wherein the composition and thickness of the ground coating layer are controlled such that the wallcovering sheet is substantially opaque.

25. The wallcovering sheet according to claim 24, wherein the design is embossed.

26. A wallcovering sheet comprising:
a) a spun-bond nonwoven substrate comprising polyester fibers; and
b) a ground coating layer applied to at least one side of the non-woven substrate, wherein said ground coating includes
i) an emulsion polymer pigment binder; and
ii) an opacifying mineral pigment composition,
wherein the nonwoven substrate is substantially free of saturant binder.

27. The wallcovering sheet according to claim 26, wherein the wallcovering sheet exhibits an ink holdout to in receptivity ratio in the range of from 1:1 to 15:1, as measured by the K&N test.

28. The wallcovering sheet according to claim 26, wherein the wallcovering sheet exhibits an ink holdout to in receptivity ratio in the range of from 2:1 to 10:1, as measured by the K&N test.

29. A wallcovering sheet comprising:
a) a nonwoven substrate having a front side and a back side, wherein the nonwoven substrate comprises at least 75 wt. percent of polyethylene terephthalate fibers;
b) a ground coating layer which is applied to the front side of the nonwoven substrate and includes:
i) an vinyl acetate-ethylene emulsion copolymer; and
ii) a mineral pigment composition, and
c) printing which is applied on the ground coating layer.

30. A method of producing a wallcovering sheet comprising the steps of:
a) forming a nonwoven substrate which comprises at least 50 wt. percent of synthetic fiber;
b) applying an aqueous ground coating composition to at least one side of the nonwoven substrate, said coating composition comprising
i) an emulsion polymer binder, and
ii) a mineral pigment composition,
c) drying the coated nonwoven substrate; and
d) printing a design on a coated surface of the nonwoven substrate.

31. A coated nonwoven sheet suitable as a substitute for vinyl sheets, wherein said nonwoven sheet includes:
a) a nonwoven substrate having a front side and a back side, wherein the nonwoven substrate includes at least 50 wt. percent synthetic polymer fibers; and
b) a ground coating layer applied to at least one side of the non-woven substrate, wherein said ground coating includes
i) an emulsion polymer pigment binder; and
ii) a mineral pigment composition,
wherein the nonwoven substrate is substantially free of saturant binder.

32. A coated nonwoven sheet suitable as a substitute for PVC substrates, wherein said nonwoven sheet comprises:
a) a spun bond nonwoven substrate having a front side and a back side, wherein the nonwoven substrate includes at least 75 wt. percent of polyethylene terephthalate fibers;
b) a ground coating layer applied to at least one side of the nonwoven substrate and directly bonded thereto, wherein said ground coating includes
i) an emulsion polymer pigment binder; and
ii) an opacifying mineral pigment composition,
wherein the nonwoven substrate is substantially free of saturant binder.

33. A coated nonwoven sheet comprising:
a) a nonwoven substrate having a front side and a back side, wherein the nonwoven substrate includes at least 75 wt. percent synthetic polymer fibers; and
b) a ground coating layer applied to at least one side of the nonwoven substrate, wherein said ground coating includes
i) an emulsion polymer pigment binder; and
ii) a mineral pigment composition which includes alumina trihydrate,
wherein the composition and thickness of the ground coating layer are controlled such that the coated nonwoven sheet is substantially opaque.

34. A coated nonwoven sheet comprising:
a) a nonwoven substrate having a front side and a back side, wherein the nonwoven substrate includes at least 75 wt. percent polyester fibers;
b) a ground coating layer applied to at least one side of the nonwoven substrate, wherein said ground coating includes
i) an vinyl acetate-ethylene emulsion copolymer; and
ii) a mineral pigment composition,
wherein the ground coating is applied such that the nonwoven substrate exhibits a decrease in roughness of at least about a 20 percent when measured according to the Parker-print roughness test using a hard backing and a 5 kg clamping force.
